(19) United States
(12) Patent Application Publication
(10) Pub. No.: US 2019/0115775 A1
(43) Pub. Date: Apr. 18, 2019

(54) METHOD AND SYSTEM FOR A CHARGER WITH REMOVABLE TRAY FOR A CARPET SEAMER

(71) Applicant: TTI (MACAO COMMERCIAL OFFSHORE) LIMITED, Macau (MO)

(72) Inventors: Casey R. Izard, Easley, SC (US); Tanmay Kavathekar, Central, SC (US); Samuel Boyles, Easley, SC (US)

(21) Appl. No.: 15/783,837

(22) Filed: Oct. 13, 2017

(51) Int. Cl. H02J 7/00; H01M 10/44; H02J 7/02

(52) U.S. Cl. CPC H02J 7/0044; H01M 10/44; B29C 66/8612; H02J 7/0052; H01M 2220/30; H02J 7/02

(57) ABSTRACT

A charger base station that receives a battery powered carpet seaming iron and includes a removable tray with an upper surface formed to receive the carpet seaming iron. The tray receives a metal insert that is formed to fit between the carpet seaming iron and the tray. The underside of the tray includes a mating formation that mates with mating formations on an upper surface of a charger base station, thus securing the tray to the charger base station. The charger base station also has an interface for receiving and mating with the battery powered carpet seaming iron, which includes electrical connection elements for connecting to the battery powered carpet seaming iron. The charger base station has an AC supply interface that is coupled to an internal power supply circuit. The power supply circuit is also coupled to the interface for receiving and matting with the battery powered carpet seaming iron.

### TECHNICAL FIELD

Embodiments described herein relate generally to providing a charger base station for a carpet seaming iron.

### SUMMARY

Embodiments described herein relate to a charger base station for a battery powered carpet seaming iron, and more specifically, providing a charger base station with a removable tray for receiving a battery powered carpet seaming iron.

In one embodiment, a system is provided for a battery charger system that receives a battery powered carpet seaming iron. The system includes a removable tray having an upper surface formed to receive the battery powered carpet seaming iron. The removable tray includes a mating formation on the underside of the removable tray. The system further includes a charger base station that has an upper surface formed for receiving the removable tray. The upper surface is configured to mate with the mating formation of the removable tray to secure the removable tray to the charger base station. Moreover, the charger base station has an interface for receiving and mating with the battery powered carpet seaming iron. The interface includes electrical connection elements for connecting to the battery powered carpet seaming iron. The charger base station also includes an alternating current (AC) supply interface and an internal power supply circuit that is coupled to the AC supply interface and the interface for receiving and matting with the battery powered carpet seaming iron.

In another embodiment, a method is provided for a battery charger system assembly. The method includes receiving a removable tray by a charger base station, receiving within the removable tray a metal insert, and receiving by the metal insert within the removable tray, a battery powered carpet seaming iron. Moreover, the battery powered carpet seaming iron is received by a battery powered carpet seamer interface in the charger base station.

In another embodiment, a battery charger system for receiving a battery powered carpet seaming iron is provided. The system includes a removable tray, a metal insert, and a charger base station. The removable tray includes a support surface and sidewalls that define a first cavity. The metal insert is received within the first cavity and defines a second cavity configured to receive an iron of the battery powered carpet seaming iron. The charger base station has an upper surface formed for receiving the removable tray, a seamer interface for receiving and mating with the battery powered carpet seaming iron, and a power supply circuit coupled to the seamer interface for receiving and mating with the battery powered carpet seaming iron.

Other features and aspects of the invention will become apparent by consideration of the following detailed description and accompanying drawings.

### BRIEF DESCRIPTION OF THE DRAWINGS

FIG. 1 is a view of a charger base station system including a charger base station with an attached removable tray and a metal insert for receiving a battery powered carpet seaming iron.

FIG. 2 is a view of a battery powered carpet seaming iron system including a battery powered carpet seaming iron that is operatively coupled to a battery pack.

FIG. 3 is a view of a charging system including the charger base station of FIG. 1 that has received the battery powered carpet seaming iron of FIG. 2.

FIG. 4 is a rotated view of the charger base station and battery powered carpet seaming iron of FIG. 3.

FIG. 5 is a view of the charger base station having the removable tray detached therefrom.

FIG. 6A is a view of the removable tray with the metal insert removed.

FIG. 6B is a view of the removable tray with the metal insert attached.

FIG. 7 is a side view cross section of the charger base station system of FIG. 1 along lines A-A.

FIG. 8 is a front view cross section of the charger base station system of FIG. 1 along lines B-B.

FIG. 9 is a flow chart for assembling the charging system of FIG. 3.

FIG. 10 is a block diagram of the charging system of FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

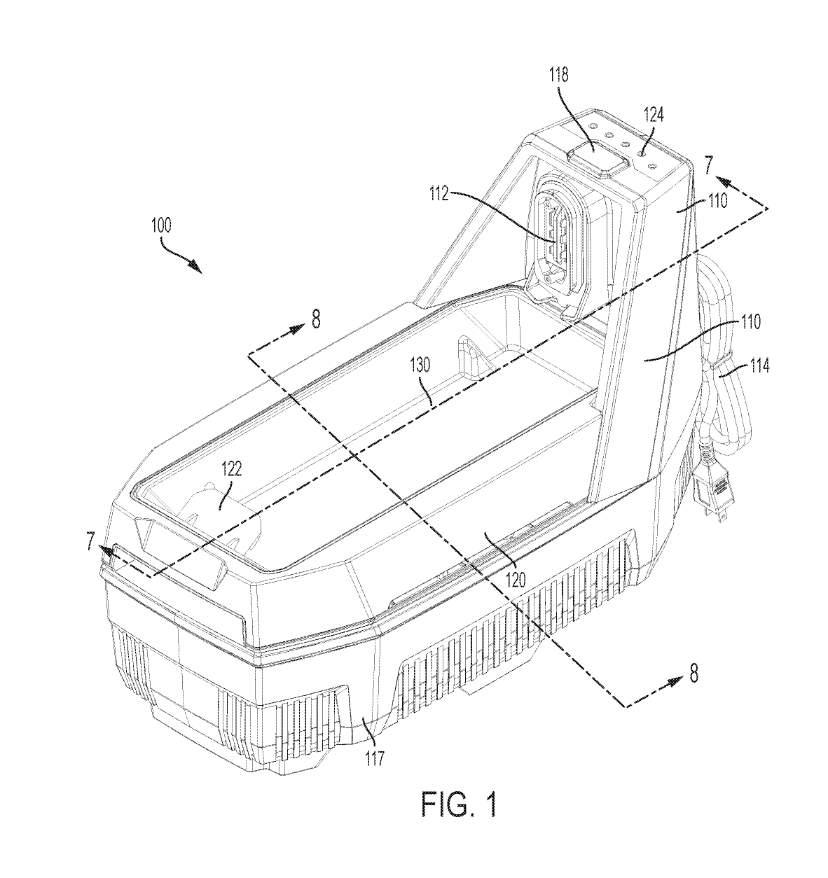

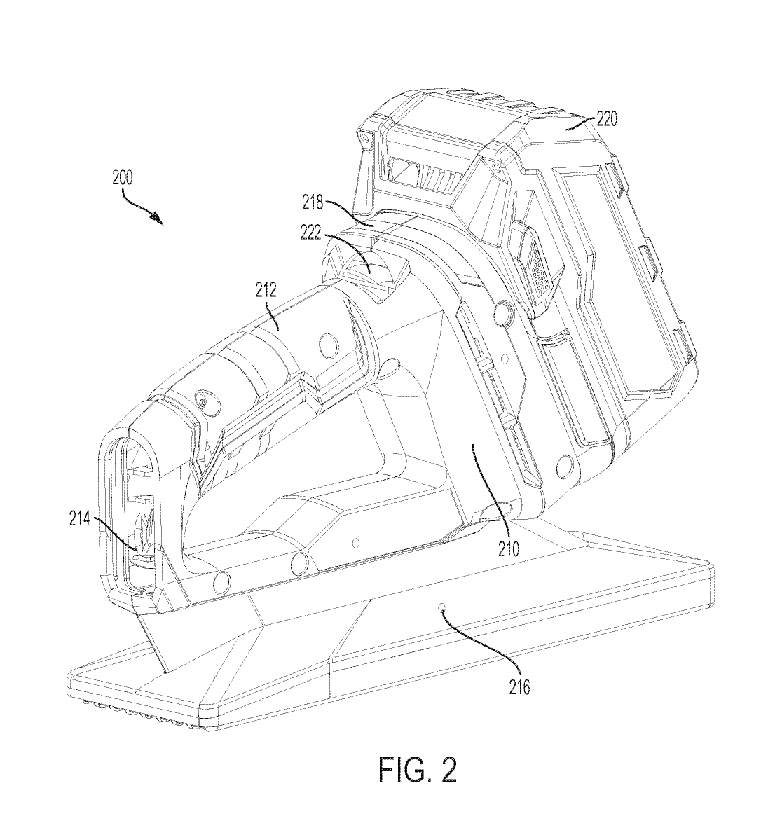

FIG. 1 illustrates a view of a charger base station system 100 for receiving a battery powered carpet seaming iron. The system 100 includes a charger base station 110, an attached removable tray 120, and a metal insert 130. The charger base station 110 further includes a battery powered carpet seamer interface 112 (also referred to as a seamer interface 112) that is configured to receive and electrically connect to a battery powered carpet seaming iron 210 (see FIGS. 2-4). The seamer interface 112 includes power output ports with electrical connection elements for providing power to the battery powered carpet seaming iron 210. The battery powered seaming iron 210 may be disconnected and detached from the charger base station 110, for example, to perform a carpet seaming operation. The charger base station system 100 illustrates the charger base station 110 when the battery powered carpet seaming iron 210 has been disconnected from the charger base station.

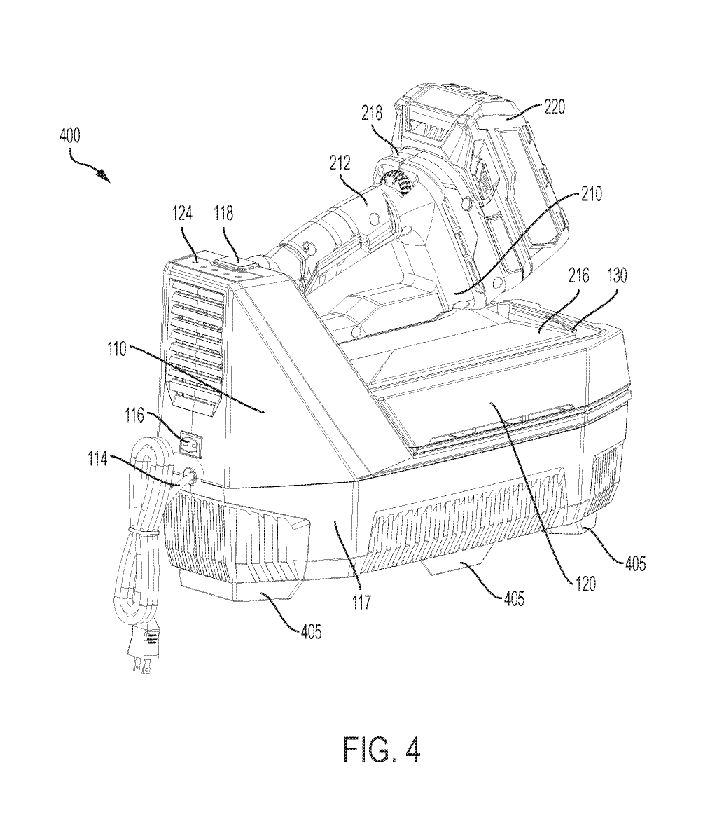

The charger base station 110 includes a plastic housing 117 and includes a tray release actuator 118, LED indicators 124, a latching mechanism 122 for securing the battery powered carpet seaming iron 210 to the charger base station 110, a cord and plug 114 for receiving AC power from an external power source such as a standard 120 VAC power outlet, and an on-off switch 116 (shown in FIG. 4) that may be controlled by a user to activate or deactivate power to the charger base station 110 for operation.

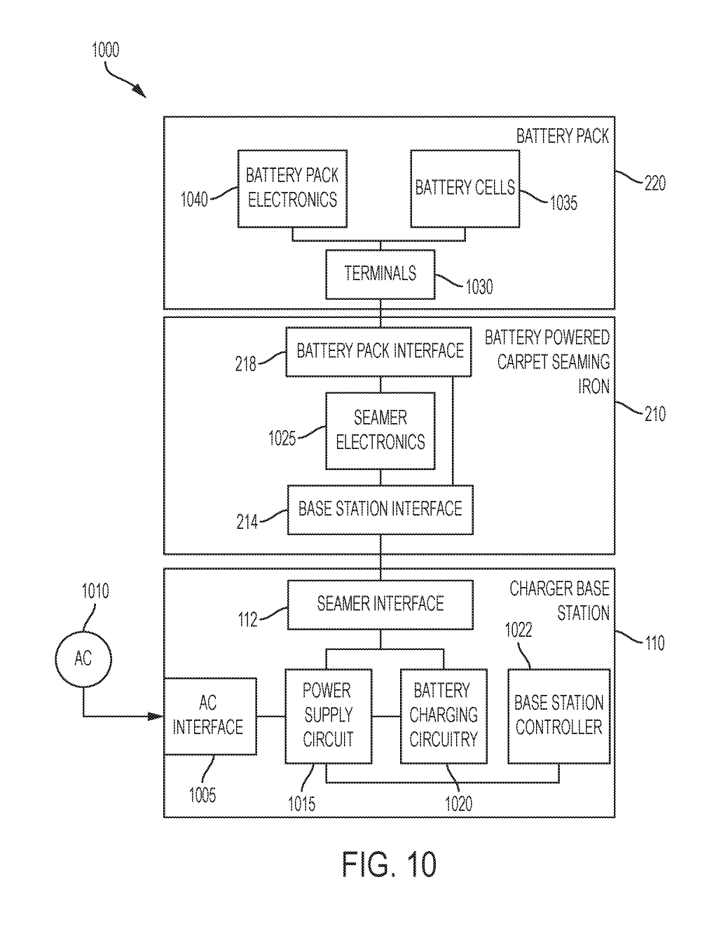

Internally, the charger base station 110 includes a power supply circuit (see FIG. 10) that is coupled to the AC supply interface 114, and to the power output ports of the seamer interface 112. The power supply circuit may adapt the VAC power input to provide direct current (DC) power for use by various elements of the battery powered carpet seaming iron 210 and for charging batteries. For example, the power supply circuit may rectify the received AC power to output DC power, and may further convert and filter the DC power to provide DC power at appropriate levels for various components of the base station system 100, a battery powered carpet seaming iron system 200 (described with respect to FIG. 2), and a battery pack 220 (described with respect to FIG. 2). A battery charger (see FIG. 10) within the charger base station 110 is coupled to the power supply and to the power output ports of the seamer interface 112. The charger base station 110 is operable to provide power to the battery powered carpet seaming iron 210 for operation of the seaming iron and to charge batteries that are connected to the battery powered carpet seaming iron 210.

In some embodiments, internally, the charger base station 110 includes a base station controller (see FIG. 10) having an electronic processor. The controller is operable to drive multiple modes of operation for supplying power by the charger base station 110 to the battery powered carpet seaming iron 210. The base station controller may be communicatively coupled to the LED indicators 124 to indicate battery charging functions, for example, indicating when the charger is providing power, when a charge cycle is complete, when a maintenance mode resumes, or when the battery charger is in an energy saving mode.

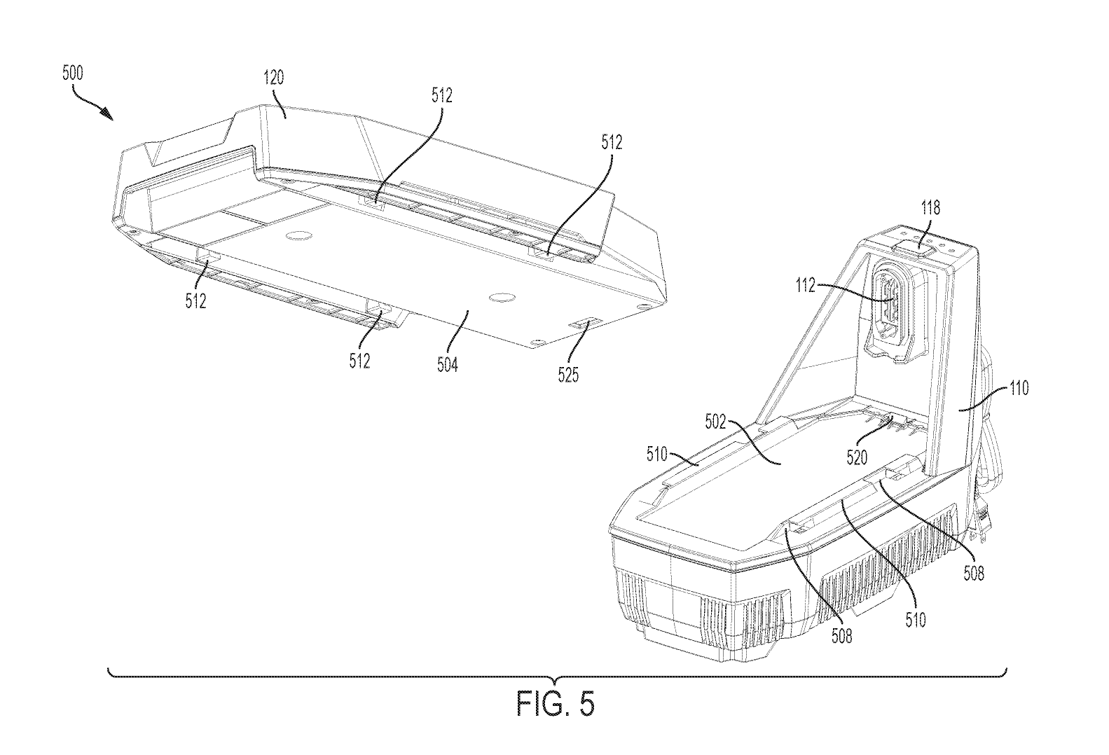

The charger base station system 100 includes a removable tray 120 that has an upper side surface that is formed to receive the battery powered carpet seaming iron 210. Formed on the underside of the removable tray 120 are mechanical connection elements that mate with connecting elements that are located on an upper surface of the charger base station 110. The charger base station 110 receives and mates with the removable tray 120 to secure the removable tray 120 to the charger base station 110 (described with respect to FIG. 5).

The charger base station system 100 may also include the removable metal insert 130 that has a contour that conforms to and fits within the formation of the upper side surface of the removable tray 120. The metal insert 130 is also configured to receive the battery powered carpet seaming iron 210. The metal insert 130 is held in place within the formed upper side surface of the removable tray 120 due to complimentary contours of an exterior of the metal insert 130 and an interior of the removable tray 120. The metal insert serves to protect the removable tray 120 from contacting excess heated glue that may have been picked-up by, and may adhere to, the iron 216 of the battery powered carpet seaming iron 210 during use of the carpet seamer. In this manner, messy heated glue may be easily cleaned from the base station system 100 by simply removing and washing the metal insert.

FIG. 2 illustrates a view of a battery powered carpet seaming iron system 200 including the battery powered carpet seaming iron 210 that is operatively coupled to a battery pack 220. As shown in FIG. 2, the charger base station 110 is disconnected from the battery powered carpet seaming iron 210.

The battery powered carpet seaming iron 210 includes a handle 212 that is operatively attached to an iron 216. The handle 212 is configured to accept a user's hand and may be used for controlling the battery powered carpet seaming iron 210 during a carpet seaming operation. The handle 212 may be formed as part of a plastic housing. The iron 216 may include, for example, a heating element (not shown) and an iron base plate heated by the heating element for melting glue during a carpet seaming operation.

Internally, the battery powered carpet seaming iron 210 includes an electronic controller (not shown) that manages operations on the carpet seaming iron 210. The electronic controller may include an electronic processor that is communicatively coupled to input and output mechanisms, for example, LEDs (not shown), a user heat control mechanism 222, and an internal temperature sensor (not shown) for monitoring heat levels of the iron 216.

The battery powered carpet seaming iron 210 is configured to receive and electrically connect to the battery back 220 via electrical connections within a battery pack interface 218, which mate with and electrically connect to battery terminals (see FIG. 10) within the battery pack 220. The battery pack 220 may provide power to the battery powered carpet seaming iron 210 via the battery pack terminals, for example, when the battery powered carpet seaming iron 210 is disconnected from the charger base station 110 for a carpet seaming operation. Internally, the battery pack 220 includes battery cells and a battery pack controller (see FIG. 10) that may comprise an electronic processor. The battery pack controller may determine charge and/or temperature levels in the battery cells and may communicate a status of charge levels to the battery powered carpet seaming iron 210 and/or the charger base station 110 to signal when to begin or end charging. The battery pack controller is further configured to control discharge of the battery cells.

The battery pack 220 may also be disconnected and removed from the battery powered carpet seaming iron 210. The battery pack 220 is selectively attachable to and removable from the battery powered carpet seaming iron 210. For example, the battery pack 220 and the battery powered carpet seaming iron 210 may include physically mating features (e.g., rails and grooves) and a latching mechanism to secure the battery pack 220 to the battery powered carpet seaming iron 210 and enable selective removal of the battery pack 220. Additionally, in some embodiments, the battery pack 220 is configured to attach to and power a variety of other power tools including drill-drivers, impact drivers, nailers, circular saws, jig saws, reciprocating saws, and other devices including work lights, radios, fans, and the like.

In instances when the battery powered carpet seaming iron 210 is disconnected from the base station 110, as shown in FIG. 2, the carpet seaming iron 210 may be put to use for seaming a carpet. For example, in some instances the battery powered carpet seaming iron 210 may be removed by a user from the charger base station system 100 and the carpet seaming iron 210 may continue to receive power from the battery pack 220 to melt glue and perform carpet seaming operations.

The carpet seamer handle 212 further includes a base station interface 214 that has electrical connection elements that mate with and electrically connect with the charger base station 110 via the electrical connection elements in the power output ports of the seamer interface 112. In this regard, the power supply unit within the charger base station 110 is operable to supply power to the battery powered carpet seaming iron 210 via the power output ports of the seamer interface 112 and the base station interface 214, for example, to heat the iron 216 and power the electronic controller circuitry of the battery powered carpet seaming iron 210.

The charging power provided by the battery charger within the charger base station 110 may be directed to battery cells (see FIG. 10) within the battery pack 220 via the battery powered carpet seaming iron 210. For example, the charging power may be provided first to the battery powered carpet seaming iron 210 via the base station power output ports of the seamer interface 112 and base station interface 214 of the battery powered carpet seaming iron 210. The battery powered carpet seaming iron 210 may further direct the charging power to the battery terminals of the battery pack 220 via the battery pack interface 218. In some embodiments, the battery powered carpet seaming iron 210 includes one or more LED light indicators, for example, to indicate the heating status of the iron 216.

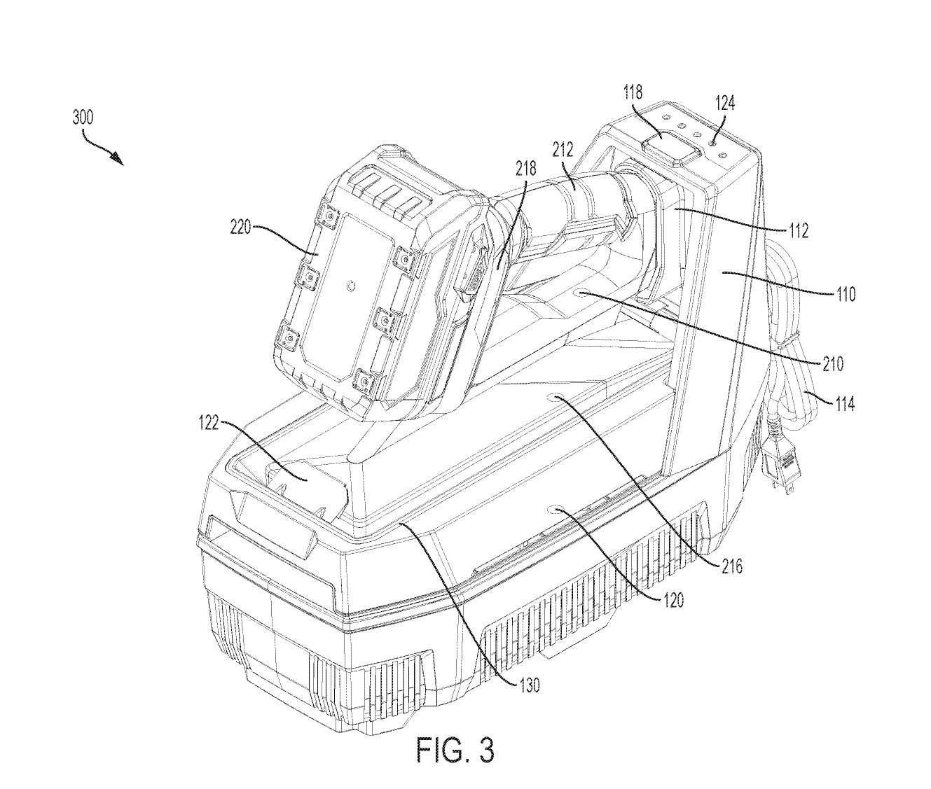

FIGS. 3-4 illustrate a charging system 300 including the charger base station 110 having received the battery powered carpet seaming iron 210. The charger base station 110 includes a receptacle that is sized and configured to receive and hold the iron 216 of the battery powered carpet seaming iron 210 when it is placed into the charger base station 110 and the battery powered carpet seaming iron 210 is connected to the charger base station 110. For example, the base station interface 214 is mated to and electrically connected to the power output ports in the seamer interface 112 of the charger base station 110. Moreover, the underside of the removable tray 120 is secured to an upper surface of the charger base station 110, and the metal insert 130 is held in place between the removable tray 120 and the iron 216 of the battery powered carpet seaming iron 210.

Referring to FIG. 3, the latching mechanism 122 of the removable tray 120 secures the battery powered carpet seaming iron 210 to the metal insert 130 and to the removable tray 120 of the base station 110. Engaging the latching mechanism 122 in this manner enables a user to carry the entire assembly of the battery powered carpet seaming iron system 200 and the charger base station system 100 by the handle 212 of the battery powered seaming iron 210. Alternatively, the metal insert 130 and/or the battery pack 220 may be removed when the latching mechanism is engaged and enables a user to carry the charger base station 110 and the battery powered carpet seaming iron 210 by the handle 212.

As shown in FIG. 4, the base station 110 further includes one or more support feet 405 downwardly protruding from the housing 117. The one or more support feet 405 support the base station 110.

FIG. 5 illustrates the charger base station 110 having the removable tray 120 detached therefrom. The charger base station 110 includes an upper surface 502 formed for receiving the removable tray 120. The upper surface 502 includes one or more connection members 510 (also referred to a connection formations 510). The removable tray 120, which may be formed from plastic resin, includes an underside surface 504 that includes one or more connection members 512 (also referred to as connection formations 512). The upper surface 502 and the one or more members 510 of the charger base station 110 are configured to mate with the underside surface 504 and the one or more members 512 of the removable tray 120, to secure the removable tray 120 to the charger base station 110.

In some embodiments, the one or more connection members 510 of the charger base station 110 and the one or more connection members 512 of the removable tray 120 comprise a drop-slide mechanism that interconnects the charger base station 110 and the removable tray 120. In one example, the one or more connection members 510 of the base station comprise a rail that forms a channel. Each channel is configured to receive a corresponding one of the one or more connection members 512 of the removable tray 120. In this manner, the one or more connection members 512 of the removable tray 120 may be received by the corresponding rail channels of the charger base station 110, and the connection members 512 may slide under the rails until the removable tray 120 reaches a position where it is securely attached to the charger base station 110. Furthermore, each of the rails may have one or more cut outs 508 that serve as entry points into the channel for the receiving the one or more connection members 512 of the removable tray 120. However, the disclosure is not limited to any specific type of securing mechanism between the removable tray 120 and the base station 110, and other suitable securing mechanism may be utilized in some embodiments.

Additionally, the base station 110 includes a locking tab 520 configured to be received in the tab receptacle 525 of the underside surface 504 of the removable tray 120. The locking tab 520 is spring-biased into the extended position illustrated in FIG. 5. In response to depression of the tray release actuator 118, the locking tab 520 disengages the tab receptacle 525 and retracts, thereby releasing a lock preventing the removal of the removable tray 120 from the base station 110.

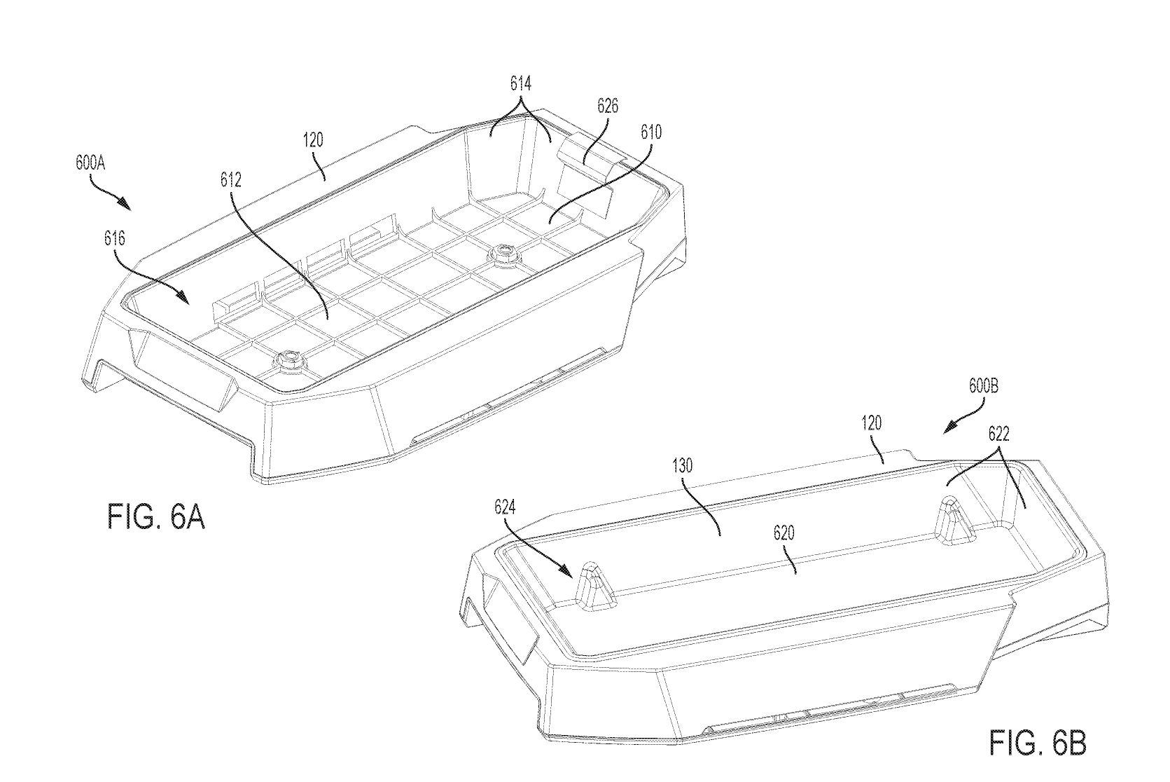

FIG. 6A illustrates a view 600A of the removable tray 120 with the metal insert 130 removed, and FIG. 0.6B illustrates a view 600B of the removable tray 120 with the metal insert 130 attached. As shown in FIG. 6A, the removable tray 120 has an upper surface 610 that has a contour that is formed to receive the shape of the iron 216 of the battery powered carpet seaming iron 210. Furthermore, the contour of the upper surface 610 is formed to receive the metal insert 130. More particularly, the upper surface 610 includes a support surface 612 having a perimeter, and sidewalls extending up from the perimeter. The support surface 612 and sidewalls 614 define a cavity 616. The cavity 616 selectively receives the metal insert 130 and iron 216.

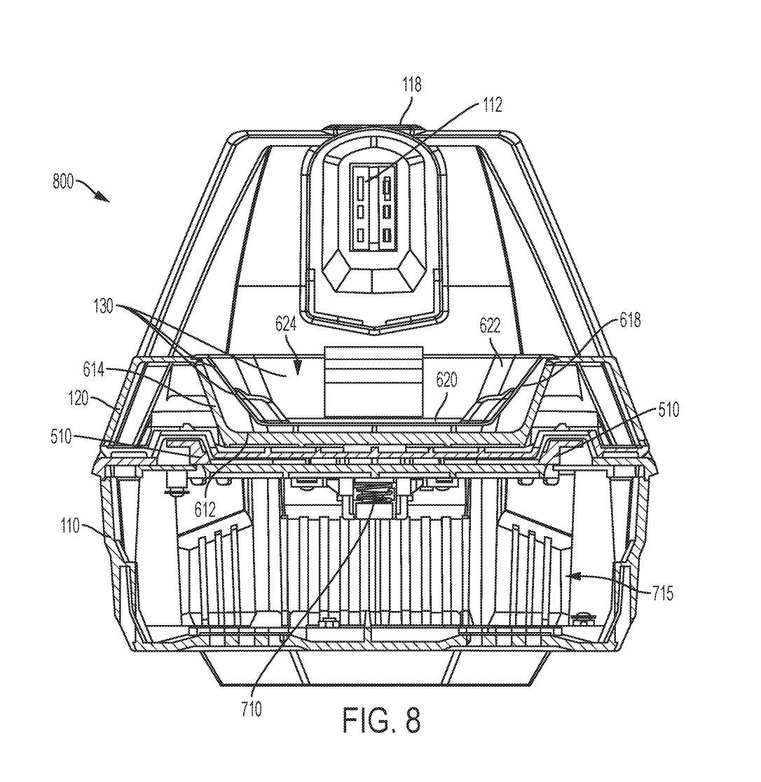

Referring to view 600B of FIG. 6B, the removable tray 120 is shown with a metal insert 130 received by the removable tray 120. The interior contour of the upper surface 610 of the removable tray 120 and an exterior contour 618 (see FIG. 8) of the lower surface of the metal insert 130 are complimentary such that the metal insert 130 stably sits within the interior contour (and the cavity 616) of the removable tray upper surface 610. Additionally, like the removable tray 120, the metal insert 130 includes a support surface 620 having a perimeter, and sidewalls 622 extending up from the perimeter. The support surface 620 and sidewalls 622 define a cavity 624. The cavity 624 selectively receives the iron 216.

Moreover, as shown in FIG. 6A, the removable tray 120 includes a mechanism 626 that secures the metal insert 130 to the removable tray 120 such that when the battery powered carpet seaming iron 210 has sticky glue adhering to the iron 216, the battery powered carpet seaming iron 210 may be removed from the metal insert 130 without pulling the metal insert 130 away from the removable tray 120.

In some embodiments, the metal insert 130 is made integral with the removable tray 120 (e.g., via adhesive or fasteners) and is not selectively removable from the removable tray 120.

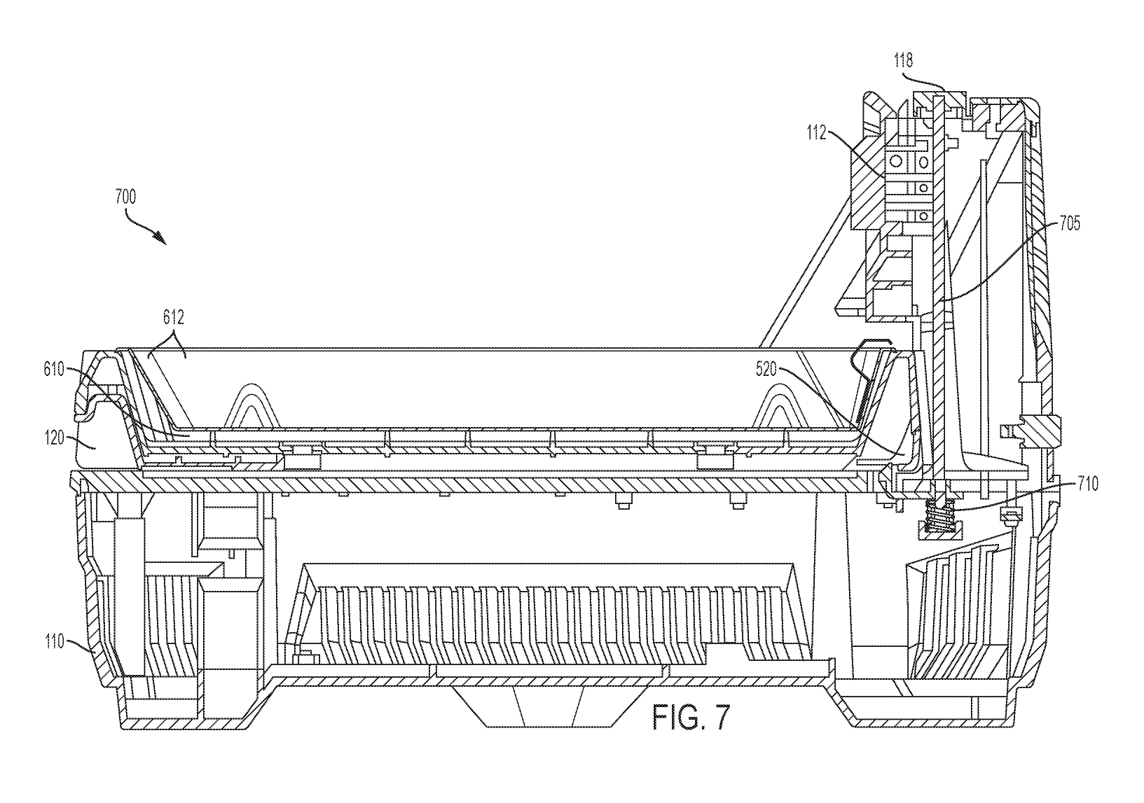

FIG. 7 illustrates a side view cross section 700 of the charger base station 110 including the removable tray 120, the metal insert 130, and the seamer interface 112. In FIG. 7, the charger base station 110 is shown attached to the removable tray 120. The metal insert 130 is held within the interior contour of the removable tray 120 upper surface 610. FIG. 7 also shows the tray release actuator 118 coupled to the locking tab 520 via a connecting rod 705 that is spring-biased by biasing spring 710. Further, FIG. 7 illustrates an electronics cavity 715 within the charger base station 110. The electronics cavity 715 is configured to house and support electronics of the charger base station 110, including the aforementioned base station controller, power supply circuit, and battery charging circuitry, which are illustrated in FIG. 10.

FIG. 8 illustrates a front view cross section 800 of the charger base station 110 including the removable tray 120, the metal insert 130, and the seamer interface 112. The front view cross section 800 of the base station system 100 shows the charger base station 110 with the seamer interface 112, and two connection members 510 for securing the removable tray 120 to the charger base station 110. The charger base station 110 is shown attached to the removable tray 120. The metal insert 130 is held within the interior contour of the upper surface 610 of the removable tray 120.

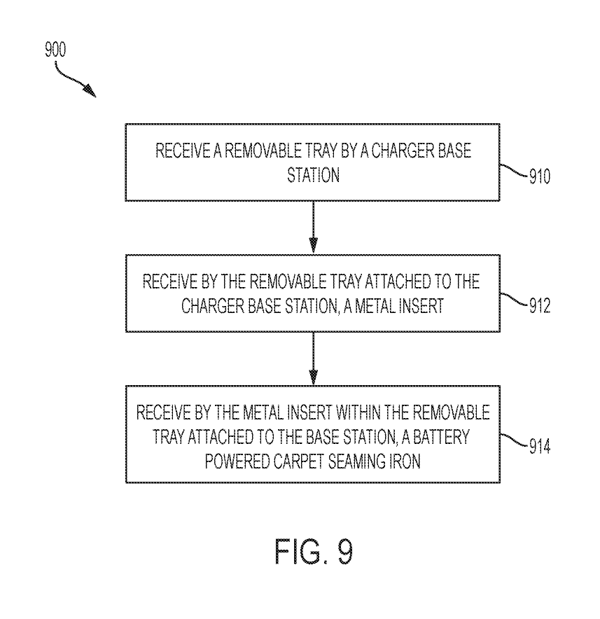

FIG. 9 illustrates a method 900 for an assembly comprising a charger base station including a removable tray and a metal insert where the assembly may be securely fastened to a battery powered carpet seaming iron. The method 900 is described with respect to the system 100 but, in some embodiments, is applicable to other systems.

Referring to FIG. 9, in step 910, the removable tray 120 is received by the charger base station 110 and is held secure by an interconnection of the one or more connection members 512 of the removable tray 120 and the one or more connection members 510 of the base station 110.

In step 912, the metal insert 130 is received by the removable tray 120 and is held secure by the latching mechanism 626 of the removable tray 120.

In step 914, battery powered carpet seaming iron 210 is received by the metal insert 130 within the removable tray 120. The battery powered seaming iron 210 is held securely fastened to the metal insert 130, the removable tray 120 and the charger base station 110 by the latching mechanism 122. Moreover, the battery powered carpet seaming iron 210 is received by and electrically connected to the seamer interface 112 of the charger base station 110.

FIG. 10 illustrates a block diagram 1000 of the charging system 300. As illustrated, the charger base station 110 includes an alternating current (AC) interface 1005, which includes the cord and plug 114, for coupling to an AC power source 1010. The AC interface 1005 provides power to a power supply circuit 1015, which rectifies and conditions the power to provide conditioned power to battery charging circuitry 1020, the seamer interface 112, and to the base station controller 1022. The battery charging circuitry 1020 converts the conditioned power to selectively provide charging power to the seamer interface 112. The seamer interface 112 provides the charging power and the conditioned power to the base station interface 214. The base station interface 214 provides the charging power to the battery pack interface 218 and the conditioned power to the seamer electronics 1025. The seamer electronics 1025 includes, for example, the aforementioned electronic controller of the battery powered carpet seaming iron 210, temperature sensor, heating element, and other electronics. The battery pack interface 218 provides the charging power to the terminals 1030 of the battery pack 220, which is used to charge the battery cells 1035. The battery pack 220 further includes battery pack electronics 1040, which include the aforementioned battery pack controller configured to control charging and discharging of the battery cells 1035. When the battery powered carpet seaming iron 210 is disconnected from the charger base station 110, the battery pack 220 is configured to provide power from the battery cells 1035, via the terminals 1030, to the battery powered carpet seaming iron 210. The battery power is received by the battery powered carpet seaming iron 210 via the battery pack interface 218 and used to power the seamer electronics 1025.

The controllers described herein are electronic controllers and may be configured to carry out the functionality attributed thereto via execution of instructions stored on a computer readable medium (e.g. data storage devices), via hardware circuits (e.g., an application specific integrated circuit (ASIC) or field programmable gate array) configured to perform the functions, or a combination thereof. For example, the base station controller, the electronic controller in the seaming iron, and the battery pack controller may each include an electronic processor coupled to a memory that stores instructions. The instructions are retrieved and executed by the electronic processors to carry out the functionality attributable thereto as described herein.

Although the invention has been described in detail with reference to certain preferred embodiments, variations and modifications exist within the scope and spirit of one or more independent aspects of the invention as described.

What is claimed is:

1. A battery charger system for receiving a battery powered carpet seaming iron, the system comprising:
a removable tray having an upper surface formed to receive the battery powered carpet seaming iron, the removable tray comprising:
a mating formation on an underside of the removable tray; and
a charger base station having an upper surface formed for receiving the removable tray, the upper surface configured to mate with the mating formation of the removable tray to secure the removable tray to the charger base station, the charger base station further comprising:
a seamer interface for receiving and mating with the battery powered carpet seaming iron, the seamer interface comprising electrical connection elements for connecting to the battery powered carpet seaming iron;
an alternating current (AC) supply interface; and
a power supply circuit within the charger base station that is coupled to the AC supply interface and is coupled to the seamer interface for receiving and mating with the battery powered carpet seaming iron.

2. The system of claim 1, wherein the upper surface of the charger base station that is configured to mate with the mating formation of the removable tray to secure the removable tray to the charger base station and the mating formation on the underside of the removable tray comprise a drop-slide mechanism that interconnects the charger base station and the removable tray.

3. The system of claim 2, wherein the upper surface of the charger base station that is configured to mate with the mating formation of the removable tray comprises a rail that forms a channel that accepts the mating formation of the removable tray.

4. The system of claim 1, wherein the removable tray includes a support surface and sidewalls that define a cavity for receipt of a metal insert and the battery powered carpet seaming iron.

5. The system of claim 1, further comprising:
a metal insert having an exterior contour that conforms to a formed upper surface of the removable tray, and is configured to receive the battery powered carpet seaming iron.

6. The system of claim 5, wherein the metal insert is located between the removable tray and the battery powered carpet seaming iron when the metal insert is received by the formed upper surface of the removable tray and the battery powered carpet seaming iron is attached to the seamer interface for receiving and mating with the battery powered carpet seaming iron.

7. The system of claim 5, wherein the metal insert is configured to protect the removable tray from contacting excess heated glue carried by the battery powered carpet seaming iron.

8. The system of claim 5, wherein the metal insert is removable from the removable tray.

9. The system of claim 5, wherein the removable tray further comprises a latching mechanism that secures the metal insert to the removable tray.

10. The system of claim 1, wherein the removable tray further comprises a latching mechanism that secures the battery powered carpet seaming iron to the charger base station.

11. The system of claim 1, wherein the removable tray is formed of plastic resin.

12. The system of claim 1, wherein
the charger base station further includes a locking tab and a tray release actuator coupled to the locking tab,
the removable tray further includes a tab receptacle configured to receive the locking tab, and
in response to actuation of the tray release actuator, the locking tab disengages the tab receptacle to release the removable tray from the charger base station.

13. The system of claim 1, wherein the power supply circuit within the charger base station provides power to the battery powered carpet seaming iron via the electrical connection elements when the battery powered carpet seaming iron is received by the removable tray and connected to the seamer interface for receiving and mating with the battery powered carpet seaming iron.

14. The system of claim 1 further comprising:
a battery charging circuit coupled to the power supply circuit within the charger base station, wherein the battery charging circuit supplies charging power to a battery pack that is coupled to the battery powered carpet seaming iron via the electrical connection elements when the battery powered carpet seaming iron is received by the removable tray and connected to the seamer interface for receiving and mating with the battery powered carpet seaming iron.

15. A method for a battery charger system assembly, the method comprising:
receiving a removable tray by a charger base station,
receiving within the removable tray a metal insert;
receiving by the metal insert within the removable tray, a battery powered carpet seaming iron; and
receiving the battery powered carpet seaming iron by a battery powered carpet seamer interface in the charger base station.

16. The method of claim 15, further comprising:
securing the removable tray to the charger base station by an interconnection of one or more connection members of the removable tray and one or more connection members of the charger base station.

17. The method of claim 15, further comprising:
securing the metal insert to the removable tray by a latching mechanism of the removable tray.

18. The method of claim 15, further comprising:
securing the battery powered carpet seaming iron to the metal insert and the removable tray by a latching mechanism of the removable tray.

19. The method of claim 15, further comprising:
electrically connecting the battery powered carpet seaming iron to the charger base station via the battery powered carpet seamer interface, wherein the battery powered carpet seaming iron is attached to a battery pack that receives charging power from the charger base station via the battery powered carpet seamer interface and the battery powered carpet seaming iron.

20. A battery charger system for receiving a battery powered carpet seaming iron, the system comprising:
a removable tray having a support surface and sidewalls that define a first cavity;
a metal insert received within the first cavity, the metal insert defining a second cavity configured to receive an iron of the battery powered carpet seaming iron; and
a charger base station having an upper surface formed for receiving the removable tray, the charger base station further comprising:
a seamer interface for receiving and mating with the battery powered carpet seaming iron, and
a power supply circuit is coupled to the seamer interface for receiving and mating with the battery powered carpet seaming iron.
